(19) United States
(12) Patent Application Publication
(10) Pub. No.: US 2026/0112096 A1
(43) Pub. Date: Apr. 23, 2026

(54) SYNTHETIC VIDEO SIMULATIONS OF PREDICTED BUILDING EQUIPMENT PERFORMANCE AND FUTURE BUILDING EQUIPMENT ISSUE IDENTIFICATION THEREFROM

(71) Applicant: Honeywell International Inc., Charlotte, NC (US)

(72) Inventors: Ramkumar A, Madurai (IN); Balasubramanian P, Madurai (IN); Senthil Nathan C, Erode (IN); George Koshy, Richmond, VA (US); Ronny Scherf, Grosshernnersdorf (DE)

(21) Appl. No.: 18/923,276

(22) Filed: Oct. 22, 2024

(51) Int. Cl. G06T 13/00; G06Q 10/20; G06Q 50/163; G06T 7/00

(52) U.S. Cl. CPC G06T 13/00; G06Q 10/20; G06Q 50/163; G06T 7/0002; G06T 2207/10016; G06T 2207/30184

(57) ABSTRACT

An example method for predicting and visualizing future building equipment performance comprises: receiving actual performance and operating condition data associated with building equipment at a site, the actual performance and operating condition data including actual performance and operating condition data received from a building management system associated with the site; predicting future operating performance and operating condition data for the building equipment at the site during a future time period; generating synthetic data indicative of the predicted operating performance and operating condition data; generating, via the synthetic data, a synthetic video simulation of the future operating performance and operating condition data; displaying, via a display of a computing device in the building management system, the synthetic video simulation of the future operating performance and operating condition data; and responsive to identification of a future building equipment issue, generating an electronic ticket to remediate a future building equipment issue.

### TECHNICAL FIELD

The present disclosure relates to systems, devices, and methods for synthetic video simulations of predicted building equipment performance. More specifically, the present disclosure relates to synthetic video simulations of predicted building equipment performance and future building equipment issue identification therefrom.

### BACKGROUND

Industrial process control and automation systems are often used to automate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human process operators routinely interact with controllers and other devices in a control and automation system, such as to review warnings, alarms, or other notifications, and adjust control or initiate performance of other operations (e.g., maintenance operations) to keep the process within desired process limits. If not properly managed, a building equipment issue such as a failure or malfunction of building equipment could escalate into an emergency, crisis, and/or disaster. Moreover, it is essential to monitor the health and functioning of various building equipment, for instance, via building management systems (BMS) systems to ensure optimal performance and achieve energy efficient goals in buildings.

Yet, at many locations, building owners may still rely on reactive maintenance (e.g., responsive to the occurrence of future building equipment issue) for fixing future building equipment issue with various building equipment (e.g., HVAC, pumps, heat exchanges, etc.). Relying solely on reactive maintenance may result in extended downtime, increased costs, and/or may negatively impact an experience of tenants and/or occupants of a building (e.g., an HVAC system experiencing a failure may lead to thermal discomfort among building occupants). Additionally, some current dashboards may provide insights into the historical performance and real-time status of the building equipment. However, to forecast when building equipment such as an elevator might require maintenance or when the HVAC system might experience a future issue (e.g., fail), manual analysis of historical data, occupancy schedules, etc. is required. This manual process is time-consuming and often inaccurate, leading to unexpected breakdowns and inefficient asset utilization.

### SUMMARY

The present disclosure relates generally to systems, devices, and methods for synthetic video simulations of predicted building equipment performance. The systems, devices, and methods can thereby yield enhanced analytics (e.g., contextualization), prediction, and remediation (e.g., resolution) of future building equipment issues such as those related to an industrial process control and automation system.

As such, the disclosure is directed to predicting operating conditions and building equipment performance for a future time period, generating synthetic data indicative of predicted building equipment performance, and displaying synthetic video simulations of predictive building equipment performance (e.g., as reflected in the claims). For instance, the systems and methods herein can utilize various real-world data (e.g., from one or more building systems including a building management system, an access control system, and a closed circuit television (CCTV) system)) to predict future operating conditions (e.g., predicted operating temperatures, predicted operating loads, predicted operating windows, etc.) and corresponding future operating performance of the building equipment operating in the predicted operating conditions.

In some embodiments, the real-world data and/or a derivative thereof (e.g., aggregated and/or preprocessed real-world data from one or more data sources) can be used to querying a trained machine-learning model which is trained to generate synthetic data indicative of future performance of the building equipment for future time period. The synthetic data can be displayed as a synthetic video simulation. The synthetic video simulation can include some or all of the information typically displayed in conjunction with real-time operation of the building equipment. For instance in some embodiments the synthetic video simulation can include identical types of information (e.g., real-time information) that is typically displayed via a display of the building management system, but instead utilizes the synthetic data as a basis for displayed information. Hence, an operator that is familiar with the typical interface (e.g., existing Human-Machine Interface (HMI employed in a BMS) can readily predict a future building equipment issue from the synthetic video simulation. Moreover, in some embodiments predicted future issue can be automatically identified (e.g., responsive to a predicted operating parameter in a synthetic video simulation exceeding a threshold). Hence, the approaches herein provide the capability to identify (e.g., automatically identify) a future issue with building equipment.

A virtual ticket can be created via a ticketing system for the future building equipment issue. For example, a virtual ticket can be created and a remediation action can be initiated to remediate the potential future issue indicated in the virtual ticket (e.g., remediate the future building equipment issue prior to a time of the predicted occurrence of the future building equipment issue). Additionally, in some embodiments the systems and methods herein allow building managers to explore different scenarios and their impacts on asset performance and/or permit building managers to visualize the outcomes of various preventive actions through interactive video simulations, as described herein.

For the above reasons, the approaches herein can mitigate downtime, repair/replacement costs, and/or any impact on tenants or occupants of buildings, as compared to other approaches so as those the rely solely on reactive maintenance.

As used herein, a future building equipment issue (i.e., a predicted building equipment issue) refers to a malfunction or breakdown of systems or devices that are integral to the operation and maintenance of a building's infrastructure such as those that are monitored by a building management system (BMS). Examples of building equipment include: heating, ventilation, and air conditioning (HVAC) systems (e.g., chillers, etc.), lighting systems, security and surveillance systems, fire safety systems, plumbing and water systems, energy management systems, and transportation systems (e.g., escalators, elevators, etc.), among others. Building equipment issues refer to any type of event that could lead to loss of, and/or disruption to, an organization's operations, services, and/or functions. Examples of future building equipment issues include an HVAC failure such as when a heating or cooling system stops functioning, resulting in uncomfortable or unsafe temperature conditions, an electrical failure such as when a power supply to lighting or security systems is interrupted, a sensor malfunction such as when a temperature, humidity, and/or occupancy sensors may fail to provide accurate data (e.g., leading to improper system responses), and/or an energy equipment failure such as a failure of a solar panels or energy storage system (e.g., leading to inefficient energy use). However, embodiments of the present disclosure are not limited to these examples. The building equipment issues may occur at a site. For instance, a site can be a single building or facility, a plurality (e.g., group) of buildings, an area (e.g., room(s), space(s), zone(s), etc.) within a building or facility, or a campus of an organization. Embodiments of the present disclosure are not limited to these examples.

A particular example of the present disclosure includes an illustrative method for predicting and visualizing future building equipment performance in connected sites, the method comprising: receiving, from one or more data sources, actual performance and operating condition data associated with building equipment at a site, the actual performance and operating condition data including actual performance and operating condition data received from a building management system associated with the site; based on the actual performance and operating condition data or a derivative of the actual performance and operating condition data, predicting future operating performance and operating condition data for the building equipment at the site during a future time period; generating synthetic data indicative of the predicted operating performance and operating condition data; generating, via the synthetic data, a synthetic video simulation of the future operating performance and operating condition data; displaying, via a display of a computing device in the building management system, the synthetic video simulation of the future operating performance and operating condition data; and responsive to identification of a future building equipment issue based on the displayed synthetic video, generating an electronic ticket to remediate the future building equipment issue.

Another example of the present disclosure includes a computing device for predicting and visualizing future building equipment performance in connected sites, the computing device comprising: a display; a memory; and a processor configured to execute executable non-transitory computer readable instructions stored in the memory to: receive, from one or more data sources, actual performance and operating condition data associated with building equipment at a site, the actual performance and operating condition data including actual performance and operating condition data received from a building management system associated with the site; analyze the actual performance and operating condition data or a derivative of the actual performance and operating condition data with a trained machine-learning model to predict future operating performance and operating condition data for the building equipment at the site during a future time period; generate, via the machine-learning model: synthetic data indicative of the predicted operating performance and operating condition data; and a synthetic video simulation using the synthetic data of the future operating performance and operating condition data; and display, via the display, the simulation of the future operating performance and operating condition data; and responsive to identification of a future building equipment issue based the displayed synthetic video simulation, generating an electronic ticket to remediate the future building equipment issue.

Another example of the present disclosure includes a non-transitory, computer-readable medium including instructions that when executed by a processor cause the processor to: a display; a memory; and a processor configured to execute executable non-transitory computer readable instructions stored in the memory to: receive, from two or more data sources, actual real-world performance and operating condition data associated with building equipment at a site, the actual real-world performance and operating condition data including actual real-world performance and operating condition data received from a building management system associated with the site; aggregate, preprocess, and clean the actual real-world performance and operating condition data associated with building equipment from the two or more data sources to form an aggregated actual performance and operating condition data set; analyze the aggregated actual performance and operating condition data set with a trained machine-learning model to predict future operating performance and operating condition data for the building equipment at the site during a future time period; generate, via the machine-learning model: synthetic data indicative of the predicted operating performance and operating condition data; a synthetic video simulation using the synthetic data of the future operating performance and operating condition data; display, via the display, the synthetic video simulation; receive an indication of a future building equipment issue, wherein the future building equipment issue is identified based the future operating performance in the synthetic video simulation; and responsive to receipt of the indication of the future building equipment issue, automatically generating an electronic ticket to remediate the future building equipment issue.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for synthetic video simulations of predicted building equipment performance and future building equipment issue identification therefrom;

FIG. 3 is an example of a flow diagram showing an illustrative process for synthetic video simulations of predicted building equipment performance and future building equipment issue identification therefrom.

FIG. 4 is an example of a graphical user interface for synthetic video simulations of predicted building equipment performance and future building equipment issue identification therefrom; and

FIG. 5 is a flow diagram showing an illustrative method for synthetic video simulations of predicted building equipment performance and future building equipment issue identification therefrom.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

It will be appreciated that industrial process control and automation systems require maintenance and upkeep, as well as rapid and effective responses to building equipment issues in an industrial plant (e.g., as indicated by various alarms and warnings) to maintain the industrial plant in an efficient, safe and productive environment. Various personnel such as process operators, system maintenance engineers, control engineers, field engineers, technicians may make decisions and perform maintenance and/or remediation actions to ensure the industrial process control and automation systems run under normal operating conditions. Managing and effectively deploying a large workforce of individuals and technicians is important for the efficient operation of industrial process, control, and automation systems within an industrial plant. Due to the occurrence of systematic building equipment issues and/or foreseeable building equipment issues at a site it is desired to proactively perform maintenance and/or alter operation of building equipment to mitigate a need for reactive response to actual building equipment issues (e.g., failures). That is, typical reactive maintenance (e.g., responsive to the occurrence of an actual real-time issue with various building equipment (e.g., HVAC, pumps, heat exchanges, etc.) may result in extended downtime, increased costs, and/or may negatively impact an experience of tenants and/or occupants of a building (e.g., an HVAC system experiencing a failure may lead to thermal discomfort among building occupants). Thus, the timely, effective, and proactive remediation of future (e.g., predicted or anticipated) building equipment issues is desired. Accordingly, the systems and methods herein are configured to generate synthetic video simulations that permit identification of future building equipment issues, as described herein.

For instance, the systems and methods herein can utilize data from a plurality of data sources (e.g., a first type of data from a building management system and a second type of data from one or more of an access control system, a video surveillance system, a weather forecasting system, a scheduling system, a maintenance log system, or any combination thereof) to enhance the accuracy of predictions of future building equipment issues. That is, the systems and methods herein can aggregate real-world data from a plurality of real-world data sources to form an aggregated data set. The aggregated data set can be used to query a trained machine-learning model to predict a future occurrence of a future building equipment issue with a high degree of accuracy (e.g., greater than 95% accuracy), as compared to other approaches such as those that rely solely on BMS data and/or rely on manual analysis of data.

Additionally, the systems and methods herein permit readily remediating predicted building equipment issue (e.g. prior to a predicted time of occurrence of the building equipment issues), as detailed herein. For instance, an electronic ticket can be generated (e.g., automatically generated) responsive to the detection of a predicted building equipment issue. The electronic ticket can include information (e.g., a predicted time of occurrence of the predicted building equipment issue, an identifier of the building equipment with the predicted issue, etc.) that permits a technician or other individual to resolve or mitigate the predicted issue, for instance, prior to the predicted time of occurrence of the building equipment issue (e.g., prior to an actual occurrence of a building equipment issue in the building equipment that is predicted to experience the issue).

Due to the accuracy of the prediction of the future building equipment issues and/or readily remediating the predicted building equipment issues (e.g., prior to a predicted time of occurrence of the building equipment issues), the system and methods herein can result in the improved operation of various systems (e.g., increasing a percentage of normal run-time operation of a site and/or improving the functioning of a BMS associated with the site such as an industrial site). Moreover, the system and methods herein can permit readily quantifying the effectiveness of the building equipment issue prediction, for instance, to permit continual or periodic training (e.g., retraining) of various machine-learning model employed to predict the occurrence of future (yet to occur) building equipment issues. For example, a percentage of predicted building equipment issues (e.g., associated with low priority building equipment, etc.) may be permitted to potentially occur (e.g., anticipatory remediations of the building equipment are not performed) to thereby permit determination of an accuracy of the predicted building equipment issues and/or to permit retraining of the machine-learning model, based thereon, as described herein. Additionally, in some embodiments the systems, devices, and methods herein can display real-time performance metrics (e.g., key performance indicators) associated with predicted building issues and/or permit the display of a real-time status of any past, present, or needed remediations associated with the predicted building equipment issues.

Thus, the systems, devices, and methods herein can yield improved functioning of various devices and individuals (e.g., operators, maintenance workers, etc.) associated with one or more sites, as detailed herein. For instance, the systems, devices, and methods herein permit the display of graphical user interfaces (in the form of live dashboards displaying various real-time information, as detailed herein). Building equipment operation can therefore be quantified and evaluated in various manners which were not previously possible with legacy dashboards or other approaches. For instance, the systems, methods, and devices herein can yield real-time key metrics (e.g., a quantity, a type, and/or a status of both real-time building equipment issues over a period of time that may occur and along with the predicted building equipment issues for a future period of time). Moreover, the approaches herein yield enhanced (e.g., proactive, timely, consistent, and effective) building equipment issue resolution, as detailed herein. The resultant benefits mentioned herein can yield safer and more effective building management and thereby can improve the efficiency and operation of various components (e.g., equipment) in the site.

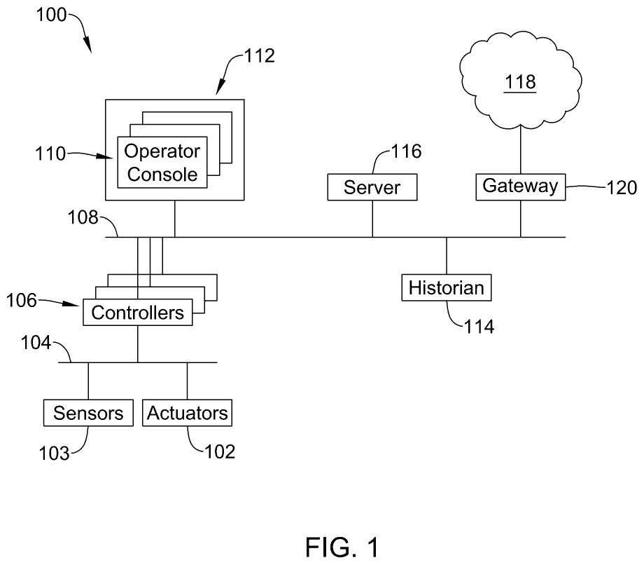

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant, manually controlled, or a combination thereof. The control and manipulation of the sensors 103 by the personnel or the process system of the industrial plant, or the combination thereof can be recorded by the historian, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the dashboards described herein. Alternatively or additionally, the dashboards described herein can be displayed elsewhere, for instance, at a console associated with a supervisor or other personal associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc. during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

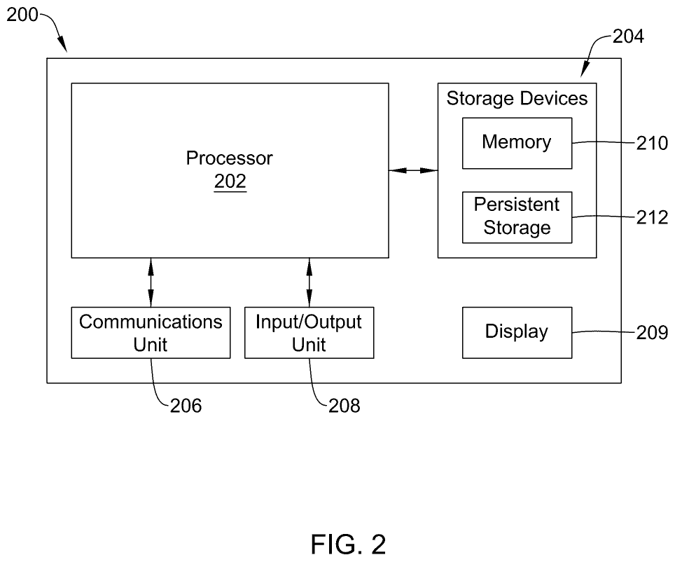

FIG. 2 illustrates an example computing device for synthetic video simulations of predicted building equipment performance. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as displaying a synthetic video simulation, collecting information, sorting and analyzing the information as well as generating a report of the analysis, and/or initiating remediation of an occurrence of a future building equipment issue for a future time period, etc. For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data. In some instances, the display 209 corresponds to a monitor. In some embodiments, the display 209 corresponds to a touch screen display that allows input and output of data.

Although FIG. 2 illustrates example computing device 200 capable of facilitating or otherwise performing at least some aspects of future build equipment issue prediction, tracking, analytics, and/or future building equipment issue remediation may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

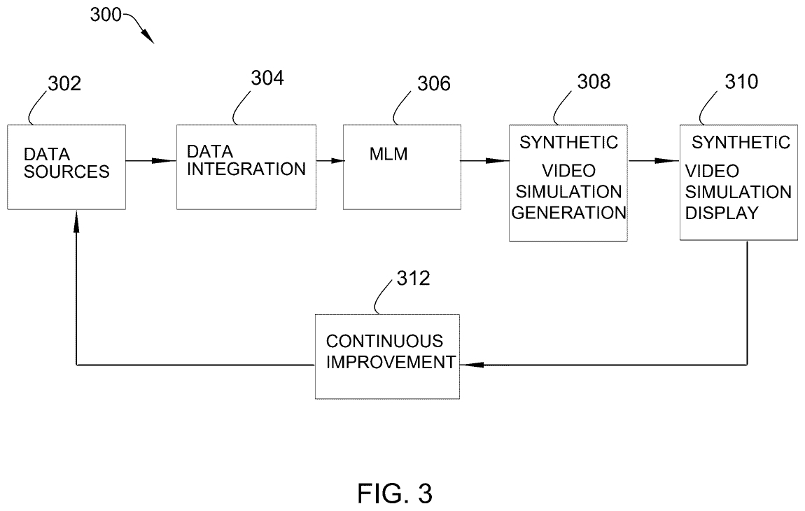

FIG. 3 is an example of a flow diagram 300 showing an illustrative process flow for synthetic video simulations of predicted building equipment performance and future building equipment issue prediction. At 302, the flow diagram 300 includes receiving, by a computing device (e.g., computing device 200 as described with respect to FIG. 2) of a building management system data from one or more data sources (e.g., the historian 114 of FIG. 2). The data can be received continuously, periodically (e.g., each minute, each hour, etc.), and/or can be received responsive to an input (e.g., responsive to an input by a site supervisor to a computing device such as the computing device 200, as described with respect to FIG. 2). The data can correspond to real-time or stored real world data that is indicative of actual performance and/or actual operating conditions associated with building equipment at a site. Examples of the one or more data sources include a building management system, such as those described herein, an access control system, a video surveillance system, a weather forecasting system, a scheduling system, a maintenance log system, or any combination thereof. In some embodiments, the one or more data sources, in addition to those data sources described above, can include data from one or more internet-of-things (IOT) devices such as proximity or occupancy sensors, smart sockets, etc.

As used herein, an access control system refers to a system that monitors and regulates entry to physical spaces, combining hardware (card readers, keypads) with software for centralized control, enhanced security, and integration with other building systems. A scheduling system refers to automates and optimizes the operation of various building systems based on pre-set schedules. Scheduling systems allow building managers or facility operators to program and manage the timing of activities such as heating, ventilation, and air conditioning (HVAC), lighting, security, and other building services to enhance energy efficiency, comfort, and operational effectiveness. A maintenance log system refers to a digital tool used to manage, track, and optimize the maintenance of building equipment, ensuring efficient operations, minimizing downtime, and supporting long-term asset management. The maintenance log system can be integrated within the broader BMS platform to provide a comprehensive view of building performance and maintenance needs. The surveillance system uses cameras, video management software, and advanced analytics to monitor and secure buildings. The surveillance system can be integrated with other security and building management tools to provide centralized control, real-time monitoring, and enhanced building safety. An example of a surveillance system is PRO-WATCH™ available from HONEYWELL™, Inc. A weather forecasting system refers to a technology used to integrate weather data with building management systems. This integration allows for optimized energy usage, enhanced safety, and more efficient operations by predicting and reacting to changing weather conditions.

In some embodiments, the data can be actual performance and operating condition data received from a building management system associated with the site. For instance, the data received from the BMS can include actual performance and/or operating condition data of one or more types of building equipment (e.g., elevators, HVAC systems, sensors, etc.) that are managed by the BMS.

In some embodiments, the data can be received from a plurality of the data sources. For instance, in addition to the data (e.g., real-world data) received from the BMS, the received data can also include data (e.g., real-world data) from one or more of: an access control system, a video surveillance system, a weather forecasting system, a scheduling system, a maintenance log system, or any combination thereof.

The received data can undergo data integration (e.g., once received by a computing device such as the computing device 200 illustrated in FIG. 2), as indicated at 304. Data integration can include data aggregation, data preprocessing, and/or data cleaning. For instance, data received from a plurality of data sources can be aggregated to form an aggregated data set (which includes the data or a derivative of the data received from the plurality of data sources).

For example, BMS data can be indicative of an actual operating performance of building equipment at a site managed by the BMS over a given time period. Such BMS data can be correlated with corresponding data from the one or more additional data sources (e.g., a video surveillance system, an access control system, etc.) to yield various additional information (e.g., an occupancy state of a region within a site, etc.). That is, video surveillance systems and access control systems can generate data related to security events, including access logs, video feeds, motion detection alerts, and entry/exit data. In such instances, data aggregation can integrate this security data with operational data (e.g., building equipment operating performance data) from the BMS. This additional information can provide an added context to the BMS data and thus can enhance the accuracy to predictions based on an aggregated data set formed from a plurality of data sources (e.g., the BMS data and data from one or more additional data sources). For example, data from access control (e.g., when a door is unlocked) can be correlated with camera footage from the same location to monitor activity more efficiently and permit enhanced predictions based thereon (e.g., yield more accurate occupancy state predictions).

In some embodiments, the data received from the data sources can undergo data preprocessing or cleaning, for instance, to make the data amenable for aggregation (e.g., from two or more data sources) and/or make the data amenable for use in querying a machine-learning model, such as those described herein. The data preprocessing or cleaning can be employed to remove inaccuracies, inconsistencies, and irrelevant information from data from one or more data sources which, if present, can negatively impact predictions made based on the data.

Examples of preprocessing of data include compression of video data received from a surveillance system, time stamp alignment of data received from two or more data sources, normalizing of sensor data received from one or more sensors (e.g., access control device in an access control system, an occupancy sensor in a room within a building, etc.), data smoothing (e.g., using moving averages to smooth operating performance data received from one or more building equipment managed by a BMS), and/or feature extraction (e.g., identifying a quantity of human individual in one or more video frames, for instance, to permit determination of an occupancy state of a room in a site), among others.

Examples of data cleaning include removing data outliers in various data such as sensor data included in BMS data, mitigating gaps in data (e.g., if access control logs of an access control system omit or miss entries e.g., due to a system issue or system reboot, the data cleaning process may impute the missing data based on the time sequence of other log, removing redundant data (e.g., reducing the number of recorded video frames when no significant motion is detected, or condensing multiple security camera logs into a single report when no events occur over long periods), correcting inconsistent time/date and/or other types of formats (where one data source uses a MM/DD/YYYY date format and another data source uses DD/MM/YYYY date format), filtering irrelevant data (e.g., Filtering out video segments where no motion is detected in a secured area, focusing only on periods with human activity), and/or duplicate entry removal (e.g., If an employee scans their badge at an entry point five times in rapid succession, only one entry is recorded, and the duplicates are removed), among others. Clean and preprocessed data provides accurate information to enhance the accuracy of predictions (e.g., predicted building equipment issues in at a future time), for instance, predictions resulting from querying a trained machine-learning model with the cleaned, preprocessed, and aggregated, as described herein.

Aggregation, preprocessing, and/or cleaning of data from one or more data sources can be performed via a rule-based process and/or a machine-learning process. For instance, in the context of a BMS or surveillance/access control systems, this could involve merging data streams from sensors, cameras, access points, and other IoT devices. As used herein, the aggregated, preprocessed, and/or cleaned data can generally be referred to as a derivative of the received data (e.g., of the received read-world data). The aggregated data set (e.g., an aggregated, preprocessed, and cleaned data set) can be stored in a centralized platform, such as ENTERPRISE BUILDINGS INTEGRATOR™ and/or FORGE; available from HONEYWELL™, Inc.

In some embodiments, the received data can include data (e.g., from a video surveillance system and/or an access control system, etc.) that is indicative of an occupancy state of one or more regions (e.g., rooms) within a site managed by the BMS. In such instances, the data from the BMS can be correlated with a given occupancy state of a region of the building (e.g., in which the building equipment is located). For instance, a given actual operating performance in time-series BMS data can be correlated with a given time occupancy state of a region in a site at various times. The given occupancy state can be determined based on the real-world data that is received. For instance, the given occupancy state of a region of a building can be determined through image analysis image of one or more images captured by a building surveillance system and/or based on a quantity of entries and exits associated with the region in a building e.g., which are determined by an access control system and indicated by access control data, etc.).

In such instances, the systems and methods herein can predict a future occupancy state of the region of the building, and based at least partially thereon, can predict a future operating performance of the building equipment in the region of the building operating at the predicted operating conditions (e.g., the predicted occupancy state). That is, the systems and methods herein can predict the future operating performance that corresponds to the future occupancy state, thereby yielding enhanced accuracy of the predicted future operating performance of the building equipment and/or increased accuracy of a prediction of future issue with the building equipment (e.g., when operating at the predicted further operating conditions, etc.).

Similarly, in some embodiments, the actual operating conditions include the atmospheric conditions at the site (e.g., managed by the BMS system). In such instances, the systems and methods herein can predict future atmospheric conditions at the site during the future time period and based at least partially thereon can predict a future operating performance of the building equipment in the region of the building operating at the atmospheric conditions. For example, building equipment such as HVAC may have differing performance based on different operating conditions (e.g., different occupancy states and/or different atmospheric conditions) can enhance an accuracy of the prediction of a future operating performance of such building equipment at a future time.

At 306, future operating performance and operating condition data for the building and/or building equipment at the site can be predicted for a future time period. For example, future operating performance and operating condition data can be predicted using actual performance and operating condition data, from 302, and/or based on a derivative of actual performance and operating condition data, from 304. In examples, future operating performance and operating condition data can be predicted based on a derivative of the operating performance and operating condition data which is manifested as an aggregated data set formed with data (e.g., preprocessed and/or cleaned data) from two or more data sources, as described herein. Namely, the aggregated data set can be used to querying a trained machine-learning model. That is, the devices and methods explained in the present disclosure involve the use of processing with various machine-learning models such as time series analysis models, regression models, anomaly detection models. The machine-learning models can be unsupervised, semi-supervised, or supervised machine-learning models.

For purposes of this disclosure, a “time series analysis model” is a machine-learning model that learns from historical time-ordered data to make predictions, detect anomalies, or classify sequences, relying on adaptive and data-driven techniques instead of strict statistical assumptions. Examples of suitable machine-learning time series analysis models include those that employ recurrent neural networks (RNNs) and/or long short-term memory (LSTM) networks, for instance, for time series forecasting and/or those that employ random forests and/or gradient boosted trees, for instance, as applied to time series data.

For purposes of this disclosure, a “regression model” is a supervised learning model used to predict a continuous numerical target variable based on one or more input features (predictors) by optimizing the regression model performance through iterative training, automatically identifying complex relationships between the input features and the output variable. The regression models can predict continuous outcomes by identifying patterns from training data, employing techniques that can capture both linear and nonlinear relationships, and improving the regression model accuracy through data-driven learning processes (e.g., via the continuous improvement mechanisms described herein). Examples of suitable regression models include linear regression models, support vector regression (SVR), random forest regression, and various neural networks used for regression tasks.

For purposes of this disclosure, an “anomaly detection model” is an unsupervised or semi-supervised learning model designed to identify rare or unusual patterns in data that deviate significantly from the majority of observations. Examples of suitable anomaly detection models include isolation forests which generally refer to an ensemble-based model that isolates anomalies by partitioning the data, autoencoders which generally refer to neural networks that learn to compress and reconstruct normal data, with high reconstruction errors indicating anomalies, one-class SVM (Support Vector Machine) algorithms which generally refer to a machine-learning algorithm that separates normal data points from potential anomalies and, LSTMs (Long Short-Term Memory networks) which are generally configured or trained to detecting anomalies in time series or sequential data.

The machine-learning models herein can be trained to detect a future issue with building equipment. For instance, the machine-learning models can be trained with an aggregated data set that includes real-world data or a derivative of real-world data from two or more data sources described herein. Training the machine-learning models with the aggregated data set can yield trained machined-learning models that are trained to detect future issues with building equipment in a site managed by a BMS with enhanced accuracy, for instance, as compared to other approaches such as those that train machine-learning models with an individual data set from an individual data source and/or that rely on manual analysis of data (e.g., manual analysis of operating condition, manual analysis of operating performance, and/or manual analysis of maintenance records associated with building equipment, etc.). For instance, the machine-learning models can be trained on an aggregated data set include BMS data and data from one or more of an access control system, a video surveillance system, a weather forecasting system, a scheduling system, a maintenance log system. Hence, the systems and methods herein can readily identify future building equipment issues with a high degree of statistical confidence (e.g., 95% or greater), as compared to other approaches such as those train machine-learning models with an individual data set from an individual data source and/or that rely on manual analysis of data. As mentioned, accurately identifying future issues can provide various benefits over other approaches such as reducing an amount of downtime of an industrial process and/or ensuring that building equipment functions as intended (e.g., to reduce costs associated maintenance and/or ensure that the site remains comfortable (e.g., an HVAC system functions as intended) for various occupants of the site.

For example, in some embodiments the machine-learning models can be queried (e.g., with an aggregated data set, as described herein) to predict future operating performance and operating condition data for the building equipment at the site during a future time period, generate synthetic data indicative of the predicted operating performance and operating condition data, and/or generate a synthetic video simulation using the synthetic data of the future operating performance and operating condition data.

The synthetic data and the synthetic video can be provided in various formats such as those typically employed with a BMS system. Examples of suitable formats for the synthetic data and the resultant synthetic video include BACnet (Building Automation and Control Network), LonWorks, Modbus, OPC (Open Platform Communications), XML (Extensible Markup Language), and/or SCADA/HMI Dashboards (Supervisory Control and Data Acquisition), among other suitable formats. For instance, in some embodiments the synthetic data and the synthetic video can be provided in a SCADA/HMI Dashboards (Supervisory Control and Data Acquisition) format, among other possibilities.

The synthetic video can be displayed via a computing device, as described herein, of a building management system, as indicated at 310. Display of the synthetic video in this manner can yield an immersive, visual representation of future asset performance scenarios, allowing building managers to intuitively understand and plan for upcoming maintenance and operational needs.

The flow 300 can include continuous improvement that can permit the machine-learning models to be trained (e.g., retrained), as indicated at 312. For example, a percentage of predicted building equipment issues (e.g., associated with low priority building equipment, etc.) may be permitted to potentially occur (e.g., anticipatory remediations of the building equipment are not performed) to thereby permit determination of an accuracy of the predicted building equipment issues and/or to permit retraining of the machine-learning model, based thereon, as described herein. Alternatively or in addition, a quantity of remediations performed for various types of future building equipment issues can be compared to a quantity of actual building equipment issues to ascertain whether or not the remediations were successful in mitigating any actual occurrence of building equipment issues that correspond to the predicted building equipment issues. These are merely examples. Other types of retaining of the machine-learning models are possible.

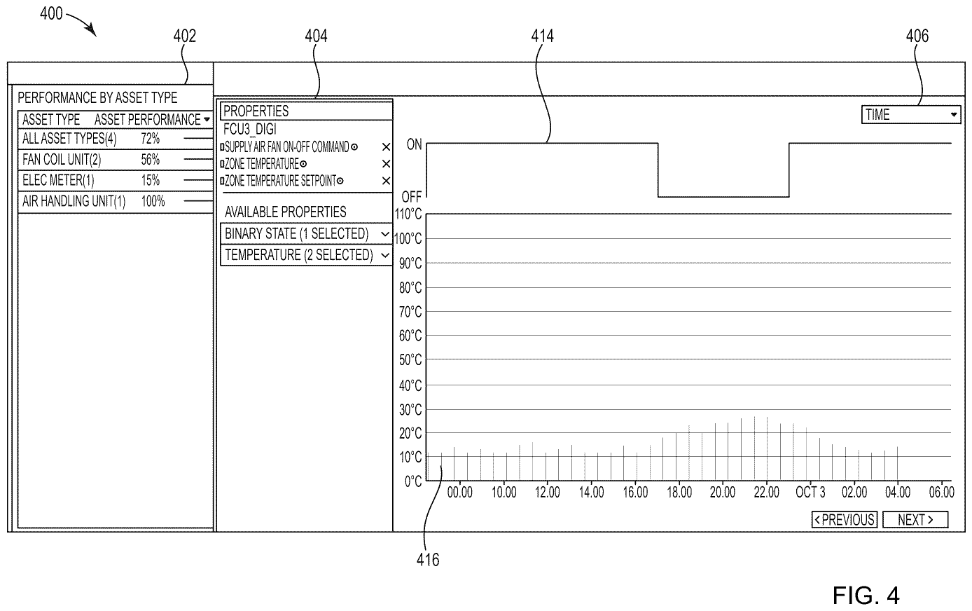

FIG. 4 is an example of a graphical user interface 400 (e.g., a human-machine interface) for synthetic video simulations of predicted building equipment performance and future building equipment issue identification therefrom. The graphical user interface 400 can be included in or displayed by a computing device such as the computing device 200, as described herein with respect to FIG. 2. The information displayed in the graphical user interface 400 can correspond to or be based on information in a synthetic video simulation of the future operating performance and/or future operating condition data associated with building equipment for a future time period.

The information displayed via the graphical user interface 400 can be tailored to a particular future time period (e.g., a day, a week, a month, a year, all time, etc.), one of more types of building equipment (e.g., as indicated at 402), one or more operating performance parameters (e.g., as indicated at 404) and/or one or more sites (e.g., an individual site, a collection of some but not all sites, or all sites, etc.). For example, as illustrated in FIG. 4 the visual representations generated for display in the graphical user interface 400 corresponds to one or more types of building equipment (e.g., air fan), one or more operating performance parameters (e.g., a predicted zone temperature), and a performance threshold (e.g., zone temperature setpoint) corresponding the one or more operating parameters, as indicated at 404. The information can be displayed for a future time period, e.g., over a 24-hour time period at a future data in time (e.g., as selected via the dropdown menu 406).

In some embodiments, the graphical user interface 400 can be configured to display a quantity of open tickets (e.g., tickets indicative of predicted future issues with building equipment that are yet to be closed remediations) and/or a quantity of closed tickets (e.g., tickets indicative of predicted future issues with building equipment that have been remediated). In some instance, the graphical user interface 400 can be configured to display one or more key-performance indicator (KPI) associated with operator, maintenance personal, ect. related to remediation of the predicted future building equipment issues. For instance, a percentage of predicted building issues that are remediated prior to a predicted time of occurrence can be determined and displayed. Thus, the approaches herein can readily, and in some instances automatically, generate one or more KPI related to the timely remediation of predicted future building issues (e.g., prior to a predicted time of occurrence of the future building issue).

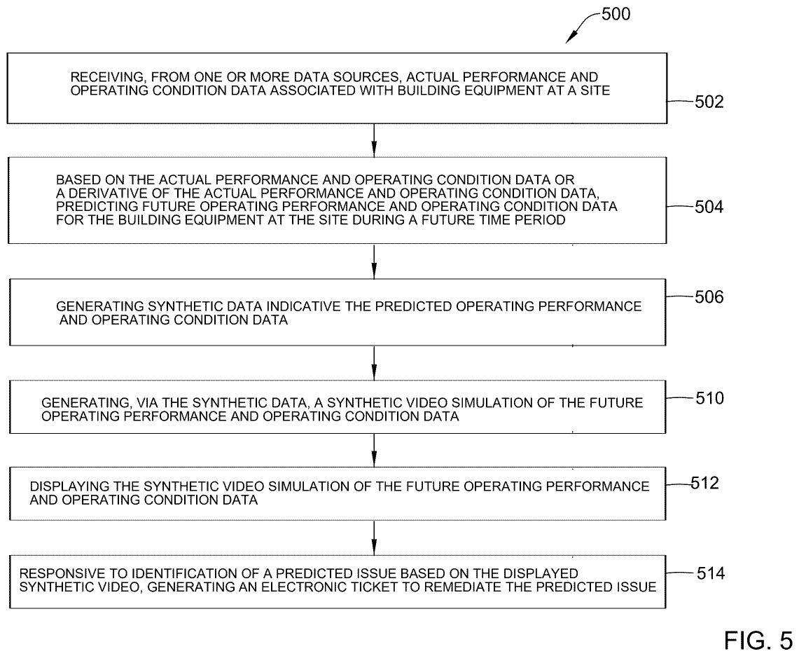

FIG. 5 is a flow diagram showing an illustrative method 500 for synthetic video simulations of predicted building equipment performance and future building equipment issue identification therefrom. At 502, the method 500 includes receiving, by a computing device (e.g., computing device 200 as described with respect to FIG. 2) of a building management system, actual performance and operating condition data associated with building equipment at a site (e.g., managed by the BMS) for a time period. The actual performance and operating condition data can be received continuously, periodically (e.g., each minute, each hour, etc.), and/or can be received responsive to an input (e.g., responsive to an input by a site supervisor to a computing device such as the computing device 200, as described with respect to FIG. 2).

The method 500 can include predicting future operating performance and operating condition data for the building equipment at the site during a future time period (that has yet to occur at a time of the prediction). For instance, the method 500 can, based on the actual performance and operating condition data or a derivative of the actual performance and operating condition data, predict future operating performance and operating condition data for the building equipment at the site during a future time period, as indicated at 504. For example, the future operating performance and operating condition data can be predicted by querying one or more trained machine-learning models, as described herein.

The method 500 can include generating synthetic data indicative of the predicted operating performance and operating condition data, as indicated at 506. For example, the synthetic data indicative of the predicted operating performance and operating condition data can be predicted by querying one or more machine-learning models, as described herein. Stated differently, the synthetic data can be an output from one or more trained machine-learning models, as described herein.

The method 500 can include generating, via the synthetic data, a synthetic video simulation of the future operating performance and operating condition data, as indicated at 510. For example, the synthetic video simulation of the future operating performance and operating condition data can be generated by querying one or more trained machine-learning models, as described herein. Stated differently, the synthetic video simulation of the future operating performance and operating condition data can be an output from one or more trained machine-learning models, as described herein.

The method 500 can include displaying, via a display of a computing device in the building management system, the synthetic video simulation of the future operating performance and operating condition data, as indicated at 512 and as detailed herein. The method 500 can include displaying the synthetic video simulation prior to the future time period (e.g., to permit identification and remediation of future building equipment issues predicted to occur in the future time period), as detailed herein. In some embodiments, the method 500 can include altering, responsive to an input from an operator of the computing device, one or more operating conditions associated with the synthetic video simulation, one or more operating parameters of the building equipment, or both; and responsive to the alteration, displaying an updated synthetic video simulation including the one or more altered operating conditions, the one or more altered operating parameters, or both.

The method 500 can include generating an electronic ticket to remediate a predicted future issue. For instance, the method 500 can include generating an electronic ticket to remediate the predicted future issue, responsive to identification of a predicted issue based on the displayed synthetic video, as indicated at 514. In some embodiments, the method 500 includes automatically generating the electronic ticket for remediation of the predicted building equipment issue of the building equipment responsive to receipt of an indication of the presence of the predicted issue, where the indication of the presence of the predicted building equipment issue comprises an automatically generating indication or a manual indication provided via an operator of the computing device.

As mentioned, a predicted occurrence of the future building equipment issue can be identified based at least on the future operating performance of the building equipment in the synthetic video simulation. For instance, the predicted occurrence of the future building equipment issue can be identified by an operator of a computing device displaying the synthetic video simulation. However, in some embodiments, the predicted occurrence of the future building equipment issue can be identified automatically, for instance, based a predicted deviation from a set point, failing to meet a performance threshold, or other indicator of a predicted operating performance failure of the building equipment during the future time period.

In some embodiments, predicting the occurrence of the predicted issue includes predicting a time of the occurrence of the future issue. In such instances, the virtual ticket can include an indication of the time of occurrence of the predicted issue. Including a predicted time of occurrence of the future building equipment issue can promote aspects herein such as promoting remediation of the predicted building equipment issue prior to the predicted time of occurrence of the future building equipment issue.

In some embodiments, the method 500 includes automatically initiating a remediation action to remediate the predicted building equipment issue of the building equipment responsive to the generation of the electronic ticket, as described herein. For instance, the electronic ticket and/or a remediation action included in or associated with the electronic ticket can be assigned to one or more individuals associated with the building equipment having the predicted issue. Hence, the individual that the ticket and/or remediation action is assigned to can remediated predicted future issue prior to a predicted time of occurrence of the future issue. Example of remediation actions such as cleaning and/or lubricating building equipment, altering one or more set points of equipment, altering equipment (e.g., replacing one or more components of the building equipment), altering an alarm sequence, and/or altering a type and/or quantity of alarms, etc. are possible. These are merely examples and other remediation actions such as those that are typically performed in accordance with sites managed by a BMS may be performed.

In some embodiments, the systems and methods herein can be configured to generate and display, via the computing devices described herein, a report indicative of one or more of: a quantity of predicted issues; identifiers of building equipment with a predicted issue; a quantity of remediation actions, electronic tickets, or both, associated with the predicted issues; and a status of the remediation actions, electronic tickets, or both, associated with the predicted issues. Display of the report summarizing aspects associated with prediction and remediation of future issues with building equipment can promote aspects herein such as a permitting an operator or supervisor to readily quantify in real-time various information aspects associated with prediction and remediation of future issues with building equipment.

In some embodiments, the system and methods herein can predict a plurality of failures, and can generate and display, via the computing device, a report indicative of a prediction accuracy of the plurality of predicted issues, where the prediction accuracy is representative of a quantity of predicted issues that correspond to actual failures of the building equipment.

In some embodiments, the method 500 can include displaying a visual representation of a status of the remediation action. For instance, the via a graphical user interface such as those described herein. Thus, the systems, devices, and methods herein can permit identification of remediation actions based on actual (real-time information) and can provide visual representations of actual (real-time) information indicative of a status of on-going remediations, thereby providing site managers with an enhanced wholistic vantage of various aspects pertaining to building management including the proactive remediation of predicted future issues with building equipment. For instance, in some embodiments, the methods herein can display a visual representation of a total quantity and/or type of completed remediation actions, display a visual representation of a total quantity and/or type of pending (yet to be completed) remediation actions, or both. In some embodiments, the visual representations of the status of the remediation action can be specific to the site, specific to one or more operators associated with the site, or both.

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for predicting and visualizing future building equipment performance in connected sites, the method comprising:
receiving, from one or more data sources, actual performance and operating condition data associated with building equipment at a site, the actual performance and operating condition data including actual performance and operating condition data received from a building management system associated with the site;
based on the actual performance and operating condition data or a derivative of the actual performance and operating condition data, predicting future operating performance and operating condition data for the building equipment at the site during a future time period;
generating synthetic data indicative of the predicted operating performance and operating condition data;
generating, via the synthetic data, a synthetic video simulation of the future operating performance and operating condition data;
displaying, via a display of a computing device in the building management system, the synthetic video simulation of the future operating performance and operating condition data; and
responsive to identification of a future building equipment issue based on the displayed synthetic video, generating an electronic ticket to remediate the future building equipment issue.

2. The method of claim 1, further comprising displaying the synthetic video simulation prior to the future time period.

3. The method of claim 2, wherein the one or more data sources further comprise one or more of: an access control system, a video surveillance system, a weather forecasting system, a scheduling system, a maintenance log system, or any combination thereof; and wherein the method further comprising aggregating the data from the access control system, the video surveillance system, the weather forecasting system, the scheduling system, the maintenance log system, or any combination thereof, with the actual performance and operating condition data received from a building management system to form an aggregated data from two or more data sources, and wherein the future operating performance and operating condition data for the building equipment is predicted based on the aggregated data.

4. The method of claim 1, further comprising identifying an occurrence of the future building equipment issue based at least on the future operating performance of the building equipment in the synthetic video simulation.

5. The method of claim 4, further comprising automatically identifying the predicted building equipment issue based on the predict future operating performance failing a performance threshold associated with the building equipment.

6. The method of claim 4, further comprising automatically generating the electronic ticket for remediation of the future building equipment issue responsive to receipt of an indication of the presence of the future building equipment issue, wherein the indication of the presence of the future building equipment issue comprises an automatically generating indication or a manual indication provided via an operator of the computing device.

7. The method of claim 6, further comprising automatically initiating a remediation action to remediate the future building equipment issue responsive to the generation of the electronic ticket.

8. The method of claim 4, wherein predicting the occurrence of the future building equipment issue includes predicting a time of the occurrence of the future building equipment issue, wherein the virtual ticket includes an indication of the time of occurrence of the future building equipment issue.

9. The method of claim 8, wherein predicting the future operating performance and operating condition data comprises querying a trained machine-learning model to obtain the future operating performance and operating condition data.

10. The method of claim 9, further comprising training the machine-learning model to predict:
future operating condition data of the building equipment based on historical operating conditions, current operating conditions, or both; and
future operating performance data of the building equipment operating in the future operating conditions.

11. A computing device for predicting and visualizing future building equipment performance in connected sites, the computing device comprising:
a display;
a memory; and
a processor configured to execute executable non-transitory computer readable instructions stored in the memory to:
receive, from one or more data sources, actual performance and operating condition data associated with building equipment at a site, the actual performance and operating condition data including actual performance and operating condition data received from a building management system associated with the site;
analyze the actual performance and operating condition data or a derivative of the actual performance and operating condition data with a trained machine-learning model to predict future operating performance and operating condition data for the building equipment at the site during a future time period;
generate, via the machine-learning model:
synthetic data indicative of the predicted operating performance and operating condition data; and
a synthetic video simulation using the synthetic data of the future operating performance and operating condition data; and
display, via the display, the simulation of the future operating performance and operating condition data; and
responsive to identification of a future building equipment issue based the displayed synthetic video simulation, generating an electronic ticket to remediate the future building equipment issue.

12. The computing device of claim 11, wherein the actual operating conditions include an occupancy state of the site, and wherein the instructions are executable to:
predict a future occupancy state of the site during the future time period; and
predict the future operating performance that corresponds to the future occupancy state.

13. The computing device of claim 11, wherein the actual operating conditions include the atmospheric conditions at the site, and wherein the instructions are executable to:
predict future atmospheric conditions at the site during the future time period; and
predict future operating performances that corresponds to the predicted operating conditions.

14. The computing device of claim 11, wherein the computing device is configured to:
alter, responsive to an input from an operator of the computing device, one or more operating conditions associated with the synthetic video simulation, one or more operating parameters of the building equipment, or both; and
responsive to the alteration, display an updated synthetic video simulation including the one or more altered operating conditions, the one or more altered operating parameters, or both.

15. A non-transitory, computer-readable medium including instructions that when executed by a processor cause the processor to:
receive, from two or more data sources, actual real-world performance and operating condition data associated with building equipment at a site, the actual real-world performance and operating condition data including actual real-world performance and operating condition data received from a building management system associated with the site;
aggregate, preprocess, and clean the actual real-world performance and operating condition data associated with building equipment from the two or more data sources to form an aggregated actual performance and operating condition data set;
analyze the aggregated actual performance and operating condition data set with a trained machine-learning model to predict future operating performance and operating condition data for the building equipment at the site during a future time period;
generate, via the machine-learning model:
synthetic data indicative of the predicted operating performance and operating condition data; and
a synthetic video simulation using the synthetic data of the future operating performance and operating condition data;
display, via a video display, the synthetic video simulation;
receive an indication of a future building equipment issue, wherein the future building equipment issue is identified based the future operating performance in the synthetic video simulation; and
responsive to receipt of the indication of the future building equipment issue, automatically generating an electronic ticket to initiate remediation of the future building equipment issue prior to a predicted time of occurrence of the future building equipment issue.

16. The medium of claim 15, further comprising automatically identifying the future building equipment issue based on the predicted future operating performance failing a performance threshold associated with the building equipment.

17. The medium of claim 15, wherein generating the electronic ticket further comprises assigning automatically assigning a remediation action to one or more individuals associated with the building equipment having the future building equipment issue.

18. The medium of claim 15, wherein the future building equipment issue is predicted to occur at a future time that is subsequent to a current time at which the synthetic video is displayed.

19. The medium of claim 15, wherein the instructions include instructions that are executable to generate and display, via the computing device, a report indicative of one or more of:
a quantity of future building equipment issues;
identifiers of building equipment having the future building equipment issues;
a quantity of remediation actions, electronic tickets, or both, associated with the future building equipment issue; and
a status of the remediation actions, electronic tickets, or both, associated with the future building equipment issue.

20. The medium of claim 15, wherein the future building equipment issue is included in a plurality of future building equipment issues, and wherein instructions include instructions that are executable to generate and display, via the computing device and video display, a report indicative of a prediction accuracy of the plurality of future building equipment issue, wherein the prediction accuracy is representative of a quantity of the plurality of future building equipment issues that correspond to actual failures of the building equipment.
